(19) United States
(12) Patent Application Publication
(10) Pub. No.: US 2012/0030510 A1
(43) Pub. Date: Feb. 2, 2012

(54) METHOD TO RECOVER DATA SECTOR DAMAGED BY ABRUPT POWER LOSS IN HARD DISK DRIVES

(75) Inventor: Ken Hong, San Jose, CA (US)

(73) Assignee: Samsung Electronics Co., Ltd., Suwon-City (KR)

(21) Appl. No.: 12/844,505

(22) Filed: Jul. 27, 2010

(51) Int. Cl. G06F 11/16; G06F 12/08

(52) U.S. Cl. 714/14; 711/112; 711/E12.019; 714/E11.054

(57) ABSTRACT

A hard disk drive that is coupled to a non-volatile memory. The non-volatile memory includes data that was designated to be stored in the hard disk drive in a previous time period. When a power loss event is detected the hard disk drive stores the track address of the last written track in non-volatile memory. When power is returned, the hard drive retrieves the last track address from the non-volatile memory. The data can then be rewritten onto the last track. Such an approach allows relatively large sectors of 4 Kbytes to be recaptured after a power loss event.

### BACKGROUND OF THE INVENTION

1. Field of the Invention

The present invention relates to a power loss event in a hard disk drive.

2. Background Information

Hard disk drives are used to store data within a system. In the event of sudden power loss, for example when a user pulls the plug on an operating system, the system will include components that allow for writing of data within the disk drive. For example, the system may include a capacitor that stores enough energy to allow the drive to complete the writing of a disk sector. Such an approach is adequate for drives that have 512 byte sectors. If the sectors are expanded, for example to 4 Kbytes per sector, then such capacitors would not have enough power to allow the drive to write a complete sector or mark potentially corrupt sectors.

### BRIEF SUMMARY OF THE INVENTION

A hard disk drive that is connected to a non-volatile memory that includes data stored upon the occurrence of a power loss, the data having been designated to be stored in the hard disk drive in a previous time period. The hard disk drive includes a circuit that causes the data stored in the non-volatile memory to be written onto a disk of the drive.

### BRIEF DESCRIPTION OF THE DRAWINGS

FIG. 1 is a top view of an embodiment of a hard disk drive;

FIG. 2 is a schematic of an electrical circuit for the hard disk drive;

FIG. 3 is a schematic showing a system with a processor, hard disk drive and non-volatile memory;

FIG. 4 is a flowchart showing a write operation of the hard disk drive; and,

FIG. 5 is a flowchart showing a hard disk drive process when power is turned on.

### DETAILED DESCRIPTION

Described is a hard disk drive that is coupled to a non-volatile memory. The non-volatile memory includes data that was designated to be stored in the hard disk drive in a previous time period. When a power loss event is detected the hard disk drive stores the track address of the last written track in non-volatile memory. When power is returned, the hard drive retrieves the last track address from the non-volatile memory. The data can then be rewritten onto the last track. Such an approach allows relatively large sectors of 4 Kbytes to be recaptured after a power loss event.

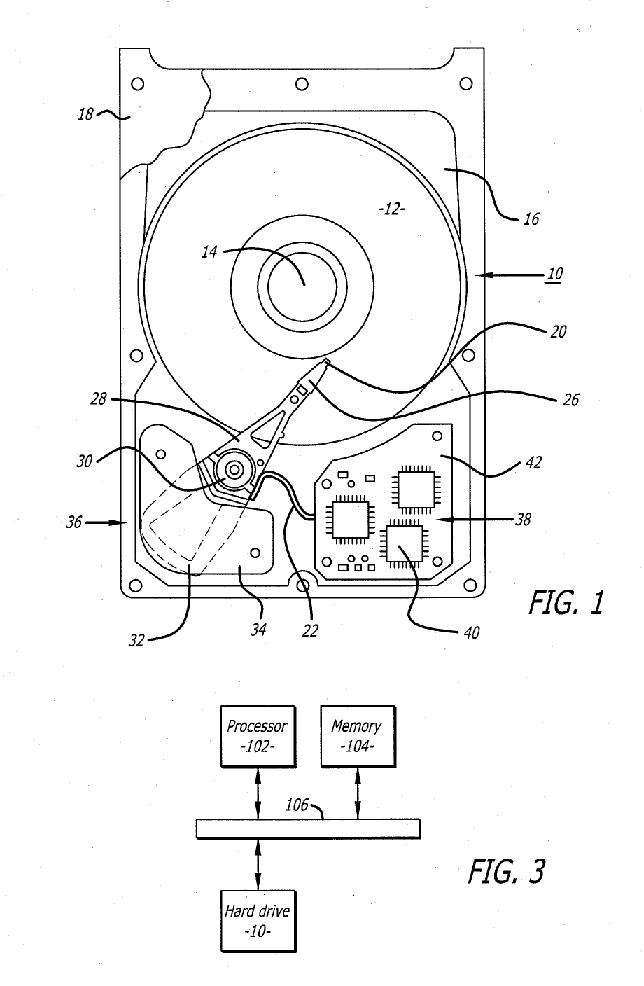

Referring to the drawings more particularly by reference numbers, FIG. 1 shows an embodiment of a hard disk drive 10. The disk drive 10 may include one or more magnetic disks 12 that are rotated by a spindle motor 14. The spindle motor 14 may be mounted to a base plate 16. The disk drive 10 may further have a cover 18 that encloses the disks 12.

The disk drive 10 may include a plurality of heads 20 located adjacent to the disks 12. Each head 20 may have separate write and read elements. The write element magnetizes the disk 12 to write data. The read element senses the magnetic fields of the disks 12 to read data. By way of example, the read element may be constructed from a magneto-resistive material that has a resistance which varies linearly with changes in magnetic flux.

Each head 20 may be gimbal mounted to a suspension arm 26 as part of a head gimbal assembly (HGA). The suspension arms 26 are attached to an actuator arm 28 that is pivotally mounted to the base plate 16 by a bearing assembly 30. A voice coil 32 is attached to the actuator arm 28. The voice coil 32 is coupled to a magnet assembly 34 to create a voice coil motor (VCM) 36. Providing a current to the voice coil 32 will create a torque that swings the actuator arm 28 and moves the heads 20 across the disks 12.

The hard disk drive 10 may include a printed circuit board assembly 38 that includes one or more integrated circuits 40 coupled to a printed circuit board 42. The printed circuit board 40 is coupled to the voice coil 32, heads 20 and spindle motor 14 by wires (not shown).

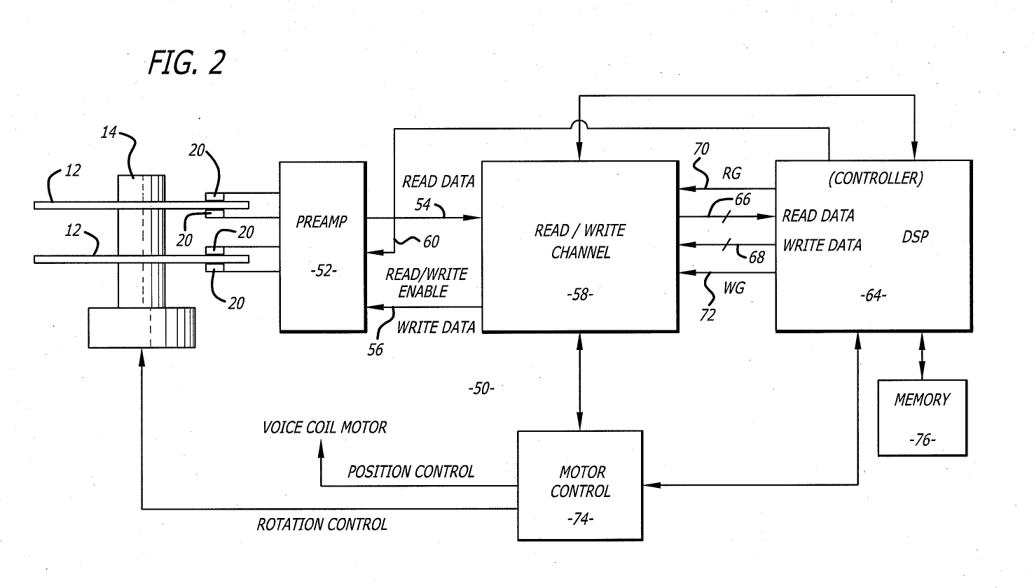

FIG. 2 shows an electrical circuit 50 for reading and writing data onto the disks 12. The circuit 50 may include a pre-amplifier circuit 52 that is coupled to the heads 20. The pre-amplifier circuit 52 has a read data channel 54 and a write data channel 56 that are connected to a read/write channel circuit 58. The pre-amplifier 52 also has a read/write enable gate 60 connected to a controller 64. Data can be written onto the disks 12, or read from the disks 12 by enabling the read/write enable gate 60.

The read/write channel circuit 58 is connected to a controller 64 through read and write channels 66 and 68, respectively, and read and write gates 70 and 72, respectively. The read gate 70 is enabled when data is to be read from the disks 12. The write gate 72 is enabled when writing data to the disks 12. The controller 64 may be a digital signal processor that operates in accordance with a software routine, including a routine(s) to write and read data from the disks 12. The read/write channel circuit 58 and controller 64 may also be connected to a motor control circuit 74 which controls the voice coil motor 36, and spindle motor 14 of the disk drive 10. The controller 64 may be connected to a non-volatile memory device 76. By way of example, the device 76 may be a read-only memory (“ROM”) that contains instructions that are read by the controller 64.

FIG. 3 shows a system 100 that includes a hard disk drive 10, a processor 102 and a non-volatile memory 104. The drive 10, processor 102 and non-volatile memory 104 are coupled together by one or more busses 106 as is known in the art. By way of example, the non-volatile memory 104 may be a flash memory device. The processor 102 may operate software routines in accordance with instructions and data as is known in the art.

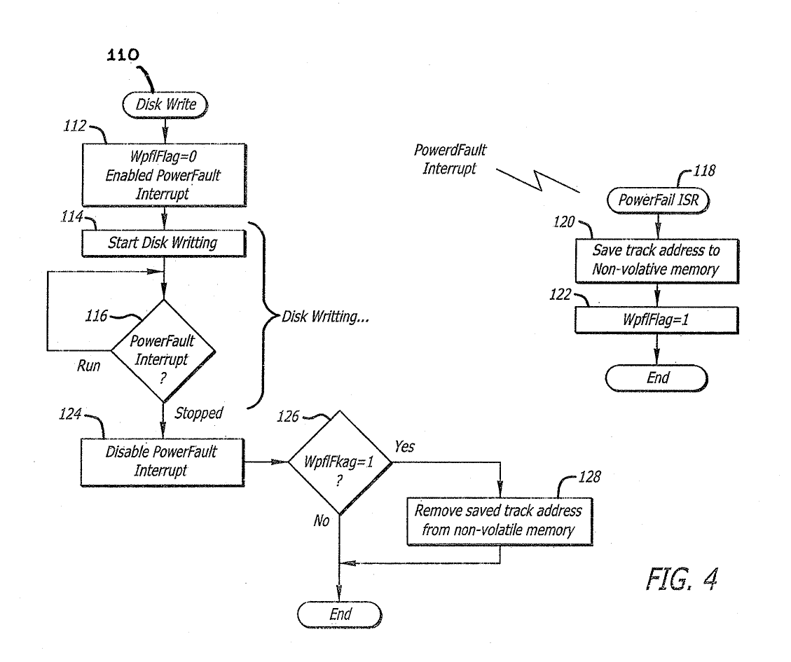

FIG. 4 shows a flowchart of a write operation within the disk drive. The drive initiates a write operation in block 110. In block 112 a write power fault flag is set to zero and a write power fault interrupt is enabled. The interrupt can be provided by the external processor to the disk drive. Data is written onto the disk in block 114 and decision block 116. A power loss may be detected which causes a power fault interrupt by the processor in block 118. The track address for the data being written in the drive is saved in the non-volatile memory in block 120. block 122 the write power fault flag is set to one.

Decision block 116 determines if there is a power fault interrupt. If no, the writing process continues. If yes, the method continues to block 124 where the power write fault interrupt within the drive is disabled. The value of the write power fault flag is determined in decision block 126. If the flag is zero the process completes the writing process and ends. If the flag is set at 1 then the data saved in the non-volatile memory is removed in block 128 and the write process continues. A flag setting of 1 in this process indicates that an interrupt occurred but power was not lost. By way of example, steps 118-122 may be performed by the processor and the remaining steps may be performed by the disk drive controller.

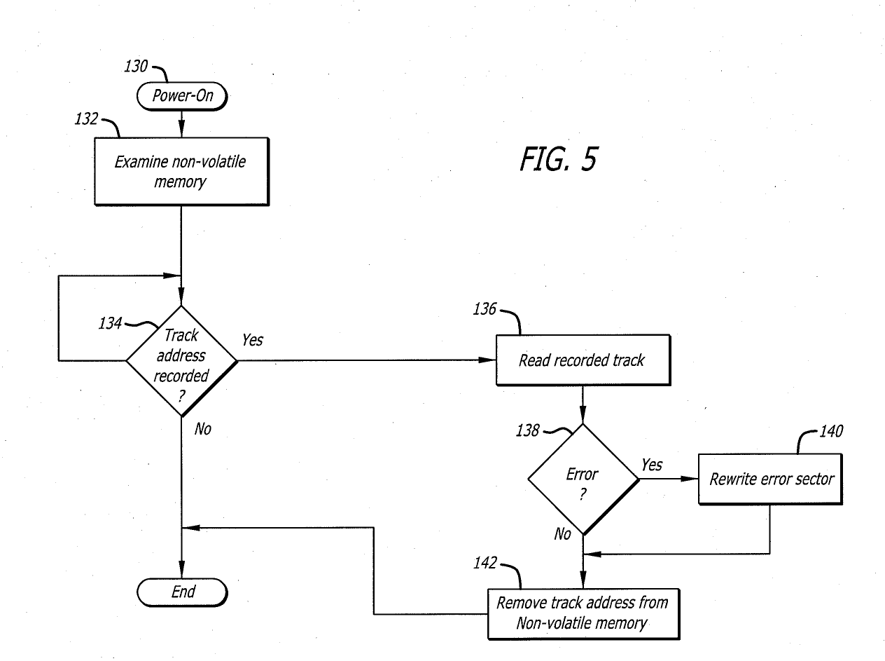

FIG. 5 is a flowchart showing a process that occurs within the disk drive when power is turned back on. The non-volatile memory is examined in block 132. Decision block 134 determines whether the non-volatile memory includes the track address of the data that was being stored during a power loss event. If not, then the process ends. If the non-volatile memory contains the track address the drive reads the corresponding track in block 136. It is determined whether there is an error in the track in decision block 138. If there is an error, the data can be rewritten onto the disk in block 140. If there is no error the track address and data are removed from the non-volatile memory in block 142. These steps may be performed by the disk drive controller.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art.

1. A hard disk drive that is coupled to a non-volatile memory, comprising:
a disk;
a head coupled to said disk;
an actuator arm coupled to said head;
a voice coil motor coupled to said actuator arm; and
a circuit coupled to said head, for storing a last track address in the non-volatile memory based on detecting a power loss event and for rewriting data onto the hard disk drive based on determining an error.

2. The hard disk drive of claim 1, wherein said circuit determines a track address at which the data was being previously recorded, reads a track associated with said track address and causes the data to be written onto said disk only if said track includes an error.

3. The hard disk drive of claim 1, wherein said circuit enables a write power fault interrupt after initiating a write operation and disables said write power fault interrupt after said write operation and checks a write power fault flag.

4. The hard disk drive of claim 3, wherein said circuit continues said write operation if said write power fault flag includes a specified value.

5. A system, comprising:
a non-volatile memory;
a hard disk drive coupled to said non-volatile memory; and,
a processor coupled to said non-volatile memory and said hard disk drive, for storing a last track address in the non-volatile memory based on detecting a power loss event and for rewriting data onto the hard disk drive based on determining an error.

6. The system of claim 5, wherein said hard disk drive determines a track address at which the data was to be previously recorded, reads a track associated with said track address and causes the data to be stored in said hard disk drive only if said track includes an error.

7. The system of claim 5, wherein said processor sets a write power fault flag, said hard disk drive enables a write power fault interrupt after initiating a write operation and disables said write power fault interrupt after said write operation and checks said write power fault flag.

8. The hard disk drive of claim 7, wherein said processor continues said write operation if said write power fault flag includes a specified value.

9. A method for saving data that is being stored in a hard disk drive during a power loss event, comprising:
storing data in a hard disk drive;
storing a last track address in a non-volatile memory based on detecting a power loss; and,
rewriting the data onto the hard disk drive based on determining an error.

10. The method of claim 9, further comprising reading the last track address when power is turned on.

11. The method of claim 10, further comprising determining a track address at which the data was be to recorded in the hard disk drive, reading a track associated with the track address and causing the data to be stored in the hard disk drive only if the track includes an error.

12. The method of claim 9, further comprising setting a write power fault flag, enabling a write power fault interrupt after initiating a write operation in the hard disk drive and disabling the write power fault interrupt after the write operation and checking the write power fault flag.

13. The method of claim 12, further comprising continuing the write operation if the write power fault flag includes a specified value.
